(19) United States
(12) Patent Application Publication
(10) Pub. No.: US 2010/0049877 A1
(43) Pub. Date: Feb. 25, 2010

(54) PERIPHERAL EQUIPMENT OPERATING METHOD, PERIPHERAL EQUIPMENT AND HOST

(75) Inventors: Jilin LI, Shenzhen (CN); Guzheng WU, Shenzhen (CN); Dong WEI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/607,693

(22) Filed: Oct. 28, 2009

Related U.S. Application Data
(63) Continuation of application No. PCT/CN2008/070840, filed on Apr. 29, 2008.

(30) Foreign Application Priority Data
Apr. 29, 2007 (CN) 200710103681.4

(51) Int. Cl. G06F 3/00

(52) U.S. Cl. 710/10; 710/20

(57) ABSTRACT

A peripheral equipment operating method, including: generating waiting data by a peripheral equipment; sending the waiting data to a host which communicates with the peripheral equipment; receiving the result returned by the host, after the host processed the waiting data by the peripheral equipment driving software. A method of assisting the operation of the peripheral equipment, including: the host which communicates with the peripheral equipment receives the waiting data from the peripheral equipment; the host processes the waiting data by the peripheral equipment driving software; the host sends the processed result to the peripheral equipment. A peripheral equipment and a host are also provided.

### CROSS-REFERENCE TO RELATED APPLICATIONS

This application is a continuation of International Patent Application No. PCT/CN2008/070840, filed Apr. 29, 2008, which claims priority to Chinese Patent Application No. 200710103681.4, filed Apr. 29, 2007, both of which are hereby incorporated by reference in their entireties.

### FIELD OF THE INVENTION

The present invention relates to electronic devices, and in particular, to a peripheral device for providing a host with a functionality service.

### BACKGROUND OF THE INVENTION

Various consumption electronic products are emerging constantly along with popularization of personal computers and flourishing development of electronic technologies. These electronic products are typically interconnected and intercommunicate with personal computers and provide users with specific functions. These electronic products, with respect to personal computer system, can generally be referred to as peripheral devices, examples of which include digital cameras, digital video recorders, wireless network cards, wireless modems, printers, etc.

The above peripheral devices, according to their characteristic of usage, may be classified into two types, i.e., independently usable peripheral devices and cooperatively usable peripheral devices. The independently usable peripheral devices refer to peripheral devices which can be used independently and provide specific functions without being connected with any personal computers, e.g., digital cameras, etc. The cooperatively usable peripheral devices refer to peripheral devices which can provide specific functions only if they are connected with personal computers, e.g., wired modems, wireless network cards, wireless modems, etc.

For a computer, work efficiency and reliability of its peripheral devices have significant influences on the operation of the entire computer system. Consequently, there would be higher requirements imposed on computer peripheral devices technologies and products performance.

Storage and operation process of firmware for an existing peripheral device is substantially the same regardless of whether an independently or cooperatively usable peripheral device. Firmware of a peripheral device is typically stored in a nonvolatile memory of the peripheral device, e.g., a Read Only Memory (ROM). When the peripheral device is powered on, the firmware is loaded from the ROM into a Random Access Memory (RAM) and then is operated normally in the RAM by a Central Processing Unit (CPU) in the peripheral device.

However, peripheral device systems become more complex as peripheral devices are increasingly functionally powerful, and therefore there is a higher requirement imposed on a processing capacity of CPUs in the peripheral devices. As the peripheral device systems become more complex, there is an objective demand for larger capacities of nonvolatile memories for storage of firmware, e.g. ROMs, and of RAMs for operation of firmware, in the peripheral devices.

### SUMMARY OF THE INVENTION

Embodiments of the invention provide a peripheral device operation method, a peripheral device and a host, so that the peripheral device has a lower requirement for a processor and memories.

An embodiment of the invention provides a peripheral device operation method including: generating, by a peripheral device, data for processing; transmitting the data for processing to a host in communication with the peripheral device; and receiving a processing result returned from the host after the data for processing is processed by drive software of the peripheral device at the host side.

An embodiment of the invention further provides a peripheral device operation assistance method including: receiving, by a host in communication with a peripheral device, data for processing from the peripheral device; processing, by the host, the data for processing by drive software of the peripheral device at the host side; and transmitting a processing result after the processing to the peripheral device.

An embodiment of the invention further provides a peripheral device including: a function unit configured to generate data for processing; and an interface unit configured to communicate with a host, transmit the data for processing generated by the function unit to the host, and receive a processing result returned from the host after the data for processing is processed by drive software of the peripheral device at the host side.

An embodiment of the invention further provides a host including: an interface unit configured to communicate with a peripheral device and receive data for processing transmitted by the peripheral device; and a processor configured to process the data for processing received by the interface unit by drive software of the peripheral device at the host side and transmit a processing result after the processing to the peripheral device.

As can be apparent from the above embodiments of the invention, with the drive software of the peripheral device at the host side instead of the firmware at the peripheral device side for data processing, the drive software of the peripheral device at the host side is stored at the host side and executed in the processor at the host side, so that there will be considerably lowered requirements for the processor and the memories at the peripheral device side.

### BRIEF DESCRIPTION OF THE DRAWINGS

FIG. 1 illustrates a flow chart of a peripheral device operation method according to the first embodiment of the invention; and

FIG. 2 illustrates a schematic diagram of structures of a peripheral device and a host according to the second and third embodiments of the invention.

### DETAILED DESCRIPTION OF THE INVENTION

The embodiments of the invention are further described in detail below with reference to the drawings to make the objects, technical solution and advantages of the invention more apparent.

The first embodiment of the invention relates to a peripheral device operation method. In this embodiment, hardware initialization instructions and communication interface initialization instructions but no firmware contents for data processing by a peripheral device are stored in an ROM of the peripheral device. The firmware contents for data processing by the peripheral device are stored in a form of drive software in a storage unit (e.g. a hard disk) of a host as drive software at the host side. The peripheral device in this embodiment is a peripheral device which needs to be connected with the host in order to cooperatively provide a specific function, e.g., a wireless data card, a wireless modem, a wireless communication module, etc.

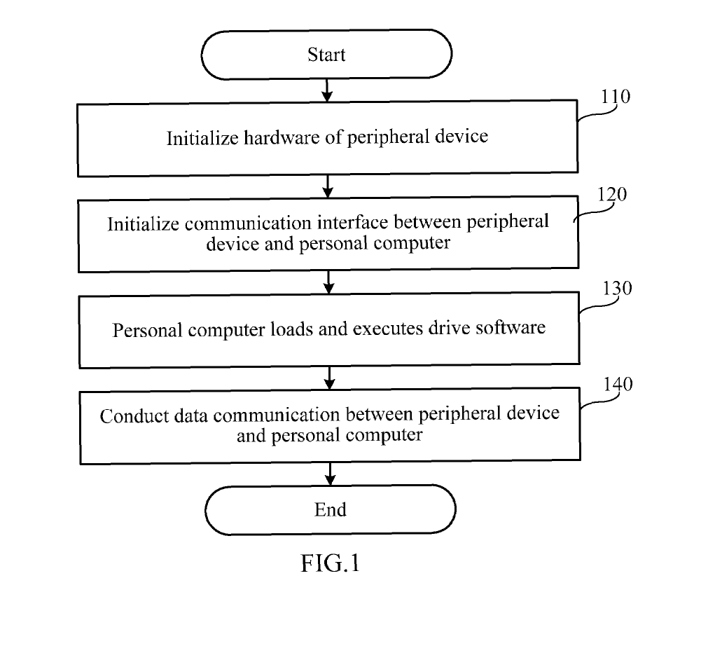

FIG. 1 illustrates a flow which will be described below by way of an example in which the host is a personal computer.

In the step 110, hardware of a peripheral device is initialized. Specifically, the peripheral device, after being connected with the personal computer and powered on, will automatically load hardware system initialization instruction stored in a ROM of the peripheral device, and thus complete status self-check and system configuration process of the hardware system of the peripheral device. This process is a necessary process for the peripheral device, and the initialization process of the hardware system varies from one peripheral device to another.

Subsequently in the step 120, a communication interface between the peripheral device and the personal computer is initialized. Specifically, the peripheral device, after completing the above hardware initialization process, will automatically load a initialization instruction of the communication interface stored in the ROM of the peripheral device, and the personal computer will also load a initialization instruction of the communication interface stored in the personal computer, thereby cooperatively completing the configuring process for a communication channel between the peripheral device and the personal computer, and implementing communication functions between the peripheral device and the personal computer.

Subsequently in the step 130, the personal computer loads and executes drive software of the peripheral device. Specifically, firstly a manufacturer of the peripheral device generates the drive software of the peripheral device in a specific format, secondly the manufacturer of the peripheral device provides a user with the drive software of the peripheral device through various possible approaches (for example, the drive software of the peripheral device is recorded in an optical disk provided to the user), and thirdly the drive software of the peripheral device is installed properly in the personal computer of the user and stored in a storage unit of the personal computer as drive software at the personal computer side.

After the peripheral device is connected with the personal computer of the user and the above processes of hardware and communication interface initialization are completed, the personal computer determines whether the drive software of the peripheral device matches the type of the peripheral device, and if there so, the drive software of the peripheral device stored in the storage unit of the personal computer is loaded into the RAM of the personal computer and dispatched and executed by an operating system of the personal computer. The drive software at the personal computer side instead of the firmware at the peripheral device side implements a corresponding data processing function, and because the drive software at the personal computer side is in the RAM of the personal computer and executed by a CPU of the personal computer, there will be a considerably lowered requirement for the processing capability of the CPU in the peripheral device.

Because the firmware contents for data processing in the peripheral device are now stored in a form of the drive software at the personal computer side in the ROM of the personal computer and loaded and executed in the RAM of the personal computer instead of in the ROM and RAM of the peripheral device, there will be considerably lowered requirements for capacities of the ROM and RAM in the peripheral device. Meanwhile, because the storage unit of the personal computer has a large capacity and a low cost of usage, a cost of manufacturing the peripheral device can be reduced greatly and competitiveness of the peripheral device in the market can be promoted. Furthermore because it is easier to update the software in the personal computer than the firmware in the peripheral device, the firmware of the peripheral device can be debugged and updated conveniently.

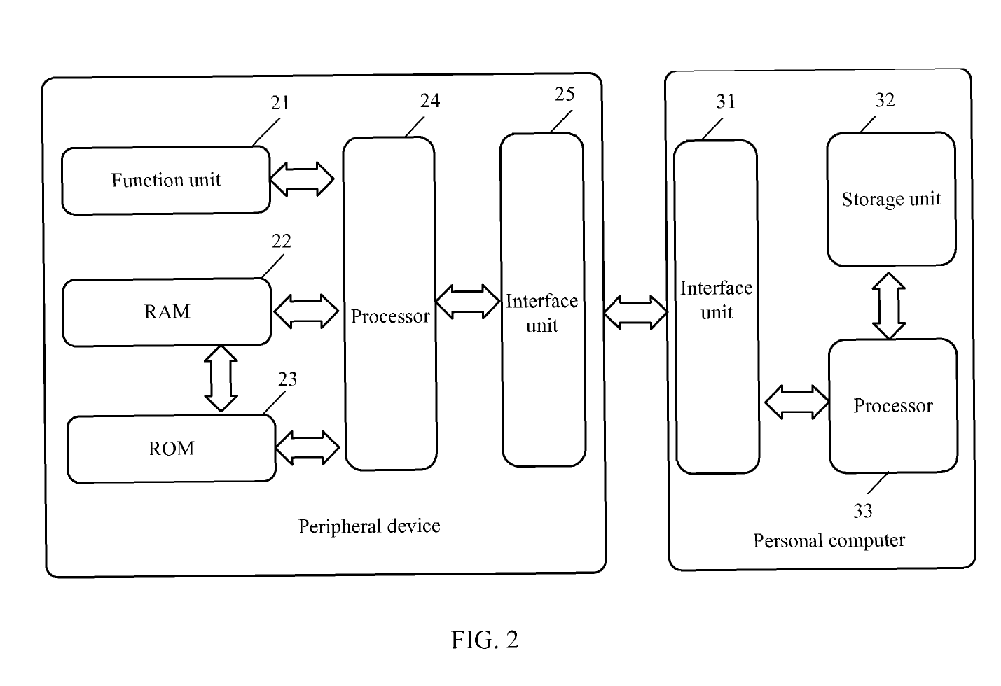

Subsequently in the step 140, data communication is conducted between the peripheral device and the personal computer. Specifically, as illustrated in FIG. 2, a processor 24 in the peripheral device transmits data for processing generated by a function unit 21 to the personal computer via an interface unit 25 at the peripheral device side and an interface unit 31 at the personal computer side. The drive software at the personal computer side processes the data for processing and transmits a processing result to a processor 24 of the peripheral device via an interface unit 31 at the personal computer side and an interface unit 25 at the peripheral device side. The processor 24 of the peripheral device forwards the processing result to the function unit 21 of the peripheral device, and the function unit 21 implements a corresponding function in accordance with the processing result.

As can be apparent from the above embodiment, from the point view of the peripheral device, the data for processing is primarily generated by the peripheral device; then the peripheral device transmits the data for processing to the host in communication with the peripheral device; and thereafter the peripheral device receive the processing result returned from the host after the drive software of the peripheral device at the host side processes the data for processing.

As can be apparent from the above embodiment, the host is primarily configured to assist the peripheral device for operation. Therefore, from the point view of the host in the above embodiment, it provides an embodiment of a peripheral device operation assistance method, in which the host in communication with the peripheral device receive the data for processing from the peripheral device; and the host processes the data for processing by the drive software of the peripheral device at the host side and transmits the processing result after the processing to the peripheral device.

With the drive software at the personal computer side instead of the firmware at the peripheral device side for data processing, the drive software at the host side is stored at the host side and executed in the processor at the host side, so that there will be considerably lowered requirements for the processor and the memories at the peripheral device side. Because the processor at the host side typically performs far superiorly to the processor at the peripheral device side, no obvious stress will be imposed on the processor at the host side due to the instructions being executed in the processor at the host side which would otherwise be executed in the processor at the peripheral device side.

On the other hand, because the drive software is stored and executed in the personal computer, the peripheral device can be prevented from updating frequently the firmware of the peripheral device during manufacturing and debugging the peripheral device, thereby improving the efficiency of manufacturing and debugging the peripheral device.

Although this embodiment has been described by way of an example of a personal computer, the host will not be limited to the personal computer, but may also include a Personal Digital Assistant (PDA), a server, etc.

The second embodiment of the invention relates to a peripheral device as illustrated in FIG. 2. The peripheral device includes a function unit 21 configured to generate data for processing; an interface unit 25 configured to communicate with the host (e.g., a personal computer), transmit the data for processing generated by the function unit 21 to the host so that the drive software at the host side performs corresponding processing of the data for processing, and receive the processing result of the data for processing, which is transmitted from the host; and a processor 24 configured to instruct the function unit to implement the corresponding function in accordance with the processing result received by the interface unit. The interface unit 25 can be a Universal Serial Bus (USB) interface or a conventional serial interface.

Particularly, the processor 24 is further configured to initialize the hardware of the peripheral device and cooperatively initialize the communication interface between the peripheral device and the host. The peripheral device in this embodiment can be a peripheral device in cooperative use with the computer, e.g., a wireless data card, a wireless modem, a wireless communication module.

Taking a wireless modem as an example, transmission and reception of wireless signals can be accomplished by the function unit, and tasks of coding/decoding, protocol processing, etc. can be accomplished by the drive software at the host side.

Because it is not necessary to store at the peripheral device side the firmware for data processing in this embodiment, there will be a considerably lowered requirement for the capacity of the ROM in the peripheral device, and data processing instructions which would otherwise be executed in the peripheral device can be executed in the host, so that the function of processor at the peripheral device side is retrogressed to merely data communication with the personal computer, and there will be considerably lowered requirements for the performance of the processor at the peripheral device side and also the capacity of the RAM at the peripheral device side, thereby saving a cost of manufacturing the peripheral device and further promoting competitiveness of the peripheral device in the market.

The third embodiment of the invention relates to a host as illustrated in FIG. 2. The host includes a storage unit 32 configured to store the drive software of the peripheral device as the drive software at the host side; a interface unit 31 configured to communication with the peripheral device and receive the data for processing transmitted from the peripheral device; and a processor 33 configured to execute the drive software at the host side and process the data for processing received by the interface unit 31. The processor 33 loads from the storage unit 32 and executes the drive software at the host side upon detecting the peripheral device. The processor 33 can be further adapted to transmit the processing result of the data for processing by the drive software to the peripheral device via the interface unit 31. The host in this embodiment can be a personal computer.

Because the processor at the host side typically performs far superiorly to the processor at the peripheral device side, no obvious stress will be imposed on the processor at the host side due to the data processing instructions being executed in the processor at the host side which would otherwise be executed in the processor at the peripheral device side. Further because the drive software is stored and executed in the host, it will be not necessary to update frequently the firmware of the peripheral device during manufacturing and debugging the peripheral device, thereby improving the efficiency of manufacturing and debugging the peripheral device.

Summarily for above, in the embodiments of the invention, with the drive software at the host side instead of the firmware at the peripheral device side for data processing, the drive software at the host side is stored at the host side and executed in the processor at the host side, so that there will be considerably lowered requirements for the processor and the memory at the peripheral device side. Because the processor at the host side typically performs far superiorly to the processor at the peripheral device side, no obvious stress will be imposed on the processor at the host side due to the data processing instructions being executed in the processor at the host side which would otherwise be executed in the processor at the peripheral device side.

Because the drive software is executed in the host, it will be not necessary to update frequently the firmware of the peripheral device during manufacturing and debugging the peripheral device, thereby improving the efficiency of manufacturing and debugging the peripheral device.

Because the firmware contents for data processing in the peripheral device are now stored in a form of the drive software at the personal computer side in the ROM of the personal computer and loaded and executed in the RAM of the personal computer instead of in the ROM and RAM of the peripheral device, there will be considerably lowered requirements for the capacities of the ROM and RAM in the peripheral device. Because it is easier to update the drive software at the host side than the firmware in the peripheral device, the peripheral device can be updated conveniently.

Although the invention has been illustrated and described with reference to some preferred embodiments of the invention, those ordinarily skilled in the art shall understand that the invention can be modified variously in the forms and details thereof without departing from the spirit and scope of the invention.

What is claimed is:

1. A peripheral device operation method comprising:
generating data by a peripheral device;
transmitting the data to a host in communication with the peripheral device; and
receiving a processing result returned from the host after the data is processed by a drive program of the peripheral device, wherein the drive program of the peripheral device is stored on the host.

2. The method according to claim 1, wherein after transmitting the data to the host in communication with the peripheral device, the method further comprises:
processing, by the host, the data by the drive program.

3. The method according to claim 1, wherein after receiving the processing result returned from the host, the method further comprises:
implementing, by the peripheral device, a corresponding function in accordance with the received processing result.

4. The method according to claim 1, wherein before generating by the peripheral device the data, the method further comprises:
initializing hardware of the peripheral device;
initializing a communication interface between the peripheral device and the host; and
loading and executing, by the host, the drive program.

5. The method according to claim 4, wherein before loading and executing by the host the drive program, the method further comprises:
storing the drive program of the peripheral device on the host.

6. A peripheral device operation assistance method comprising:
receiving, by a host in communication with a peripheral device, data from the peripheral device;
processing, by the host, the data by a drive program of the peripheral device stored on the host; and
transmitting a processing result to the peripheral device.

7. A peripheral device comprising:
a function unit, configured to generate data; and
an interface unit, configured to communicate with a host, transmit the data to the host, and receive a processing result returned from the host after the data is processed by the drive program of the peripheral device stored on the host.

8. The peripheral device according to claim 7, further comprising
a processor configured to instruct the function unit to implement a corresponding function in accordance with the processing result received by the interface unit, wherein
the function unit is further configured to implement the corresponding function in accordance with the processing result instructed by the processor.

9. The peripheral device according to claim 7, wherein the processor is further configured to initialize hardware of the peripheral device and cooperate with the host to initialize the communication interface between the peripheral device and the host.

10. The peripheral device according to claim 7, further comprising at least one of a wireless data card, a wireless modem and a wireless communication module.

11. A host comprising:
an interface unit, configured to communicate with a peripheral device and receive data transmitted by the peripheral device; and
a processor, configured to process the received data by utilizing a drive program of the peripheral device stored on the host and transmit a processing result after the processing to the peripheral device.

12. The host according to claim 11, further comprising:
a storage unit, configured to store the drive program of the peripheral device, and wherein
the processor is further configured to load from the storage unit and execute the drive program of the peripheral device upon detecting the peripheral device.
